(19) United States
(12) Patent Application Publication
(10) Pub. No.: US 2003/0016283 A1
(43) Pub. Date: Jan. 23, 2003

(54) Method of forming patterned rotary printing screens

(76) Inventor: Jesse Leskanic, Gaffney, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/907,407

(22) Filed: Jul. 17, 2001

(51) Int. Cl. B41J 2/47

(52) U.S. Cl. 347/225

(57) ABSTRACT

A method of forming a patterned rotary printing screen is disclosed. According to one embodiment, a non-photosensitive mask is applied to a mandrel, and portions of the mask are removed by a laser to expose portions of the underlying mandrel. The mandrel is immersed in a metal-plating solution according to known Galvano-type techniques so that metal is deposited in the areas where the mandrel is exposed to form a printing screen. The screen is then removed from the mandrel for subsequent screen printing operations. As disclosed herein, the processes of the present invention eliminate the need for photosensitive materials and procedures used in conventional Galvano and lacquer screen-forming processes.

### FIELD OF THE INVENTION

The present invention relates to the formation of printing screens, and more particularly relates to the use of laser-assisted Galvano processes for production of patterned rotary screens, which are suitable for screen printing of textile fabrics, paper, vinyl wallpaper, and other materials.

### BACKGROUND OF THE INVENTION

Traditional approaches to the production of rotary “halftone” printing screens often require complicated multi-step operations that utilize traditional photographic processes. For example, a conventional method for forming a rotary screen includes painting or drawing a design on paper, canvas, or similar substrate, scanning the design to produce a digital copy, and editing the digital copy to fix any errors generated by producing the digital copy. The digital copy is then reproduced on a photographic film.

A metallic cylindrical mesh screen, which can be purchased from a traditional screen manufacturer, is coated with a photosensitive polymer emulsion. The mesh is comprised of a plurality of cells, which typically range from about 1600-40,000 cells per square inch, and particularly about 14,400 cells per inch. The cells maintain the physical integrity of the screen while providing fine definition to the finished design. The coated screen is then dried, and the photographic film having the desired design is wrapped around the screen. The screen is then exposed to some form of radiation, which impacts the non-opaque areas of the photographic film and the underlying photosensitive emulsion. The radiation causes the impacted photosensitive emulsion to become cross-linked and thus resist subsequent rinsing processes. By contrast, the areas of the emulsion-coated screen that are covered by the opaque portions of the film and thus have not been exposed to the radiation are easily washed out of the screen using water. This is known as the developing process, which creates a negative image of the desired design on the screen. The “open” areas of the screen are simply the exposed mesh of the underlying screen. During the printing process, colored print pastes pass through the mesh and onto a printing substrate.

After the developing process the screen is placed in an oven and baked until the polymer emulsion is fully cured. After developing and baking, end rings or caps are installed into the cylindrical screen and the screen is then ready for use in rotary screen printing. The total cycle time to complete the screen is often between 8-10 days. The resulting screen, which is known as a “lacquer” screen, is typically used for solid color applications and fine line detail.

Other techniques are also used to produce rotary screens for decorative printing. For example, U.S. Pat. No. 5,327,167 describes laser engraving of a conventional mesh screen that has been coated with a photographic polymer emulsion and cured. A patterned screen having a desired design is produced by using the laser, which is typically a continuous wave laser having a power rating of 500-1200 watts, to burn off the cured polymeric coating or emulsion in areas of the screen that are desired to be left open. In these open areas of the pattern, the mesh features of the original screen are thus exposed as discussed above. The finished screen is similar to that described above using photosensitive polymer emulsion techniques.

A problem with laser engraving of lacquer or emulsion-coated screens is the generation of irregular patterns due to inconsistent hole alignment in the emulsion layer and the underlying mesh screen. It is generally noticed, specifically at the places at which the desired design requires that the hardened emulsion layer span only a portion of a cell in the mesh screen, that the emulsion layer is not strong enough to partially span the cell and thus is entirely removed from the cell either initially or soon after the printing operation is begun. The consequence of this complete removal is that during the printing operation, a considerable degree of definition loss is noticed at the edges of patterns. This serration effect that is created is very disadvantageous, especially when forming patterns of very fine detail.

These methods, however, suffer from several disadvantages. In particular, the use of photographic emulsion is costly and tedious, as the thickness of the emulsion applied to the screen must be consistent. In addition, the developing process delays the formation of the finished screen and uses many raw materials, and the washings or effulent must be disposed of properly to avoid environmental problems.

Another method for production of rotary printing screens utilizes a process known as the Galvano process. Instead of coating a mesh screen, the Galvano process involves coating a smooth, clean mandrel with a photosensitive polymer emulsion, which is then allowed to air dry. A photographic film having a desired design superimposed thereupon is placed over the mandrel, and the coated mandrel is exposed to radiation, such as electromagnetic radiation. After exposure to radiation, the mandrel is washed with a solvent to remove all unexposed portions of the photosensitive emulsion, while leaving areas of exposed polymer in the negative image that is desired to be produced. The final step in production of a Galvano screen is electroplating nickel on the mandrel. During the electroplating process the hardened emulsion resists the nickel such that the nickel occupies the spaces left by the unexposed emulsion that was washed away. In this manner, the hardened emulsion typically resembles a plurality of small dots on the mandrel, which result in a plurality of small holes (similar to the open mesh cells of traditional screens) when the screen is formed for permitting the print paste to pass through the screen during the printing process. The resulting nickel screen is then peeled away from the mandrel and is ready for use in a subsequent printing process.

Galvano screens perform well for tonal designs because there is no underlying mesh forming the screen as in lacquer screens. In particular, Galvano screens are made with only about 3600 cells per square inch, which therefore limits their ability to create fine lines and high definition designs. As opposed to the rigid cell shapes and sizes of lacquer screens, the cell dimensions of a Galvano screen can be formed to a variety of shapes and sizes, which are advantageous for creating tonal designs. The result is clear tonal designs of much higher quality than with lacquer screens.

Another process for manufacturing a Galvano printing screen has been developed that uses a black barrier during the formation of the screen. More specifically, the production of the screen begins by coating a mandrel with a photosensitive emulsion, and the black barrier is applied to cover the emulsion. Portions of the black barrier are removed by a laser, thus exposing the underlying photosensitive emulsion. The emulsion-coated mandrel is then exposed to electromagnetic radiation to cross-link the photosensitive emulsion in the areas where the black barrier is removed. The black barrier and unexposed photosensitive emulsion are then rinsed off with water or solvent, and the photosensitive emulsion is developed with conventional developing chemicals and techniques. The screen is formed through electrolytic deposition of nickel on the mandrel pursuant to conventional Galvano screen forming techniques.

The Galvano processes described above, however, suffer from some of the same manufacturing problems as lacquer screen processes. In particular, these Galvano processes require the costly and tedious steps of applying and curing a photosensitive emulsion on the mandrel. In addition, the photosensitive emulsion must be washed off and disposed of. Furthermore, some Galvano processes require film production of the desired image, electromagnetic radiation exposure, and other time-consuming steps. While the use of a laser to remove the black barrier covering the photosensitive emulsion avoids the need for producing a negative film and exposing the photosensitive emulsion-coated mandrel to radiation through the negative film, the time-consuming and inefficient development and washing steps of the screen are still required.

Variations and improvements of the Galvano process have been developed. For example, U.S. Pat. No. 5,338,627 describes using a laser in conjunction with the Galvano process for producing a seamless rotary screen. In this process, the mandrel having a cured photosensitive emulsion coating is rotated at a predetermined speed. The spinning mandrel is exposed to a laser beam to digitally create a pattern in the photosensitive material. The coated mandrel then undergoes a developing and washing process as discussed above, which leaves areas of the hardened photosensitive emulsion on the mandrel to serve as a resist in the Galvano electroplating operation. The mandrel is then electroplated, and the resulting nickel sleeve is removed and used as a rotary screen. The methods and systems of the '627 patent, however, still require the use of photosensitive emulsion and multiple coatings to manufacture the printing screen. In addition, the '627 patent requires the time-consuming and environmentally-harmful developing process and subsequent removal of the emulsion effluent.

Each of the above methods for producing rotary screens involves several complicated processing steps, such as coating screens or mandrels with photographic polymer emulsions and other photographic processes. The above methods may also involve removal of exposed polymer with a laser or coating metal cylinders with multiple layers of material. These processes are lengthy to perform, are expensive to carry out, and use several raw materials in forming the finished screen.

Thus, there is a need for improvement of the current state of the art. In particular, it is desirable to provide a method of producing a rotary printing screen that does not suffer from the high cost and long production time issues associated with conventional methods. In particular, it is desirable to form a rotary printing screen without the use of photographic emulsions and associated techniques.

### SUMMARY OF THE INVENTION

The present invention overcomes the disadvantages of conventional methods by providing a laser-assisted Galvano rotary printing screen process that eliminates the need for photosensitive emulsions and the associated developing techniques. Advantageously, substantial time, energy, environmental, and cost savings can occur using the methods of the present invention instead of conventional Galvano and lacquer rotary printing screen processes. According to one embodiment, a non-photosensitive or photosensitive-resistant mask is applied to a mandrel and allowed to dry. A laser removes portions of the mask to reveal the underlying mandrel, and the mandrel is plated with a metal, such as nickel, according to conventional Galvano techniques. The mask is a resist or barrier to the nickel such that the nickel is deposited in areas where the mandrel is exposed. When the electrodeposition of nickel is completed, the nickel screen is removed from the mandrel. Advantageously, the only raw material used in this embodiment besides nickel is the mask, which thereby illustrates the significant costs savings of the present invention over traditional photosensitive emulsion-based Galvano processes.

In particular, the present invention provides a method of manufacturing a printing screen that is operable for use in a rotary screen printing process, which according to one embodiment includes the steps of applying an non-photosensitive mask, such as a polymer-based material, to a generally cylindrical mandrel. A laser is used to remove at least a portion of the mask such that the mandrel is exposed where the mask is removed. Nickel is then deposited on the mandrel, such as by immersing the mandrel in a nickel plating solution and applying an electric charge thereto, so that areas where the mandrel is exposed are filled with nickel to form a nickel screen. The nickel screen is then removed from the mandrel so that the screen may be used in a screen printing operation.

### BRIEF DESCRIPTION OF THE DRAWINGS

Having thus described the invention in general terms, reference will now be made to the accompanying drawings, which are not necessarily drawn to scale, and wherein:

FIG. 1 is a perspective view of a laser engraving machine and a generally cylindrical mandrel positioned therein for forming a finished printing screen according to one embodiment of the present invention;

FIG. 2 is a perspective view of a mandrel having a non-photosensitive mask applied thereto according to one embodiment of the present invention;

FIG. 3 is a cross sectional view of the mandrel and mask as shown along lines 3-3 of FIG. 2;

FIG. 4 is a perspective side view of a mandrel having a non-photosensitive mask applied thereto being rotated while a laser removes at least a portion of the mask according to one embodiment of the present invention;

FIG. 5 is a greatly enlarged surface view of a mandrel and a non-photosensitive mask applied thereto according to one embodiment of the present invention wherein at least a portion of the mask has been removed;

FIG. 6 is a cross-sectional view of the mandrel and mask as shown along lines 6-6 of FIG. 5;

FIG. 7 is a greatly enlarged cross-sectional view of the mandrel and mask shown in FIG. 6;

FIG. 8 is a greatly enlarged cross-sectional view of a mandrel and mask that is immersed in a metal-plating solution according to one embodiment of the present invention; and

FIG. 9 is a greatly enlarged cross-sectional view of a metal screen according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

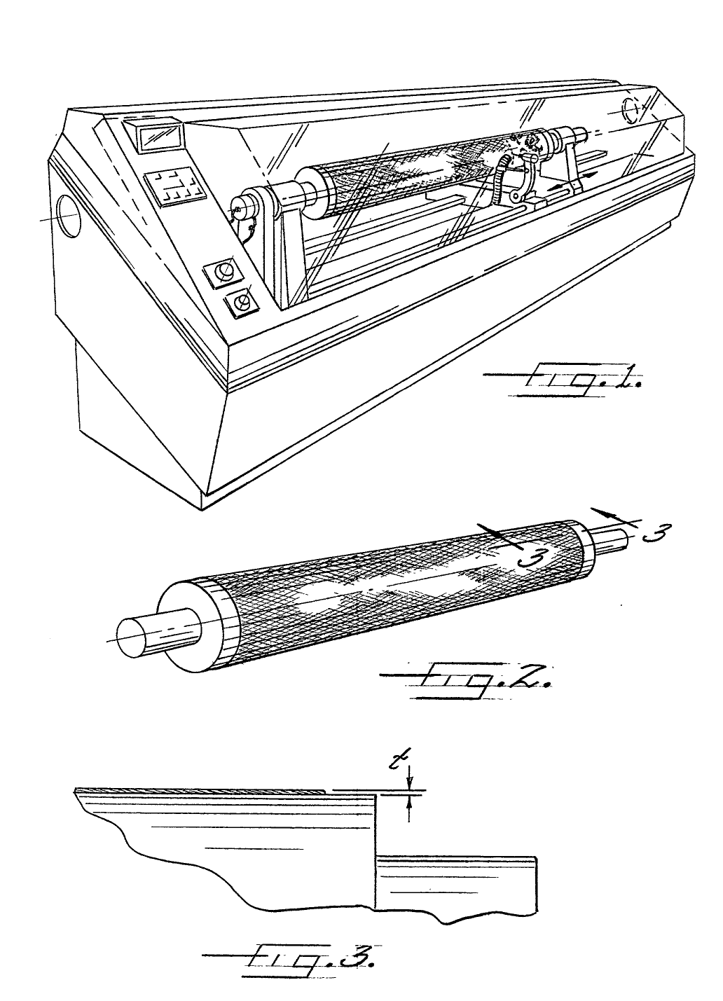

As shown in FIG. 1, the process according to one embodiment of the present invention involves forming a metallic rotary printing screen by utilizing a laser engraving apparatus or machine 20. Laser engraving machines are known in the art of screen printing, such as ScreenMaster™ laser engraving machines manufactured by ZED Instruments, Ltd. of Surrey, England. A typical engraving machine 20 includes a sealable cabinet 21 with a cover 36 operable to move between opened and closed positions. Inside the cabinet 21, the engraving machine 20 includes a rotatable headstock 28 and tailstock 30 having generally cylindrical mandrel 29 connected therebetween. The mandrel 29 of FIG. 1 is shown as including at least one layer of a “resist” or repellant material, such as an non-photosensitive mask 42, applied to at least a portion thereof. In this regard, the term “photosensitive” discussed herein is defined as referring to materials used in traditional photographic techniques for the formation of lacquer screens and particular Galvano screens discussed herein, such as photosensitive emulsions. Further, the terms “resist,” “barrier,” “repellant,” and “mask” discussed herein are defined as meaning any non-photosensitive material that can be removed or ablated, such as by a laser 34, and that acts as a repellant or barrier to the formation or electrochemical deposition of metal in a Galvano-type process, such as where the material covers the mandrel 29.

A control panel 22 is positioned on the cabinet 21, and includes controls for prescribing the rotational speed of the headstock 28 via a servomotor (not shown) that is mounted in the headstock. Others controls are also provided on the control panel 22, as discussed more fully below.

The engraving machine 20 also includes an engraving head 32 movably positioned inside the cabinet 21. The engraving head 32 is operable connected to the control panel 22, and includes a laser 34 capable of emitting focused radiation, such as a laser beam. An output lens (not shown) is mounted within the engraving head 32 for focusing the laser beam. As is conventionally known, the laser 34 and output lens are mounted in an aluminum block through which cooling water is passed. Additionally, the lens must be kept clean and any debris in the path of the laser beam must be kept to a minimum. This is achieved by using a supply of compressed air (not shown) that exhausts proximate to where the laser beam emerges.

The laser engraving machine 20 also includes a track 35 on which the engraving head 32 is movably mounted so that the engraving head and laser 34 move in a linear fashion between the headstock 28 and tailstock 30. The control panel 22 also includes controls for adjusting and controlling the laser 34 and cover 36. Other operational features are also provided, such as indicator lights 24 and an emergency stop 26.

The laser engraving machine 20 also includes a vacuum having a vacuum inlet 38 and a vacuum outlet 40 for removing vapor and airborne particles from inside the cabinet 21 of the laser engraving machine 20. In one embodiment, fresh air enters the cabinet 21 at the vacuum inlet 38 and exits via a vacuum snout 40A at the point of laser impingement on the opaque mask 42 and/or a high-speed blower/vacuum outlet 40 at the opposite end of the cabinet from the vacuum inlet. Alternatively, air may enter from both ends of the cabinet 21 and exit from the middle of the cabinet.

As shown in FIGS. 1-3, the mandrel 29 has a non-photosensitive mask 42 applied to at least a portion thereof, and preferably includes an opaque mask over substantially the entire surface of the mandrel wherein the mask has a substantially equal thickness t throughout. Although the mask 42 is not required to be opaque, such as black, an opaque mask absorbs more energy compared to a light colored or non-opaque mask, which allows the opaque mask to be removed with less energy than the light-colored or non-opaque mask. In one embodiment, the mask 42 has a thickness t of about 0.0005 inches, and preferably has a thickness in the range of 0.0001-0.0010 inches. The mask 42 is, according to one embodiment, a polymer-based material that is applied to the mandrel 29 by spraying, although other application methods could also be used. The polymer material forming the mask is preferably industrial marine acrylic, although other types of mask materials may also be used, such as epoxy urethane and the like.

Furthermore, while the mask 42 is shown and described as a single layer, it is possible that the mask could be formed by a plurality of layers or coatings having one or more thicknesses. In addition, the plurality of layers may be formed from one or more materials, wherein at least one of the layers acts as a resist or barrier when exposed to a metal plating solution.

FIGS. 4-9 show several process steps in forming a rotary printing screen according to one embodiment of the present invention. In particular, FIG. 4 shows a process step wherein the mandrel 29 having the mask 42 applied thereto is rotated about its longitudinal axis and a predetermined design 44, which has been loaded or programmed according to known techniques into the laser engraving machine 20, is created by the laser 34. As the mandrel 29 is rotated, which can be about 50 to 2000 RPM, and preferably about 1200 RPM, the engraving head 32 moves along the track 35 while “firing” or pulsing the laser 34. The laser 34 directs focused radiation, such as a laser beam, towards the mandrel 29 and mask 42 to reproduce the predetermined pattern 44 on the mandrel via the mask. According to one embodiment, the laser pulses remove portions of the mask 42, which are preferably sucked away through the vacuum snout 40A and/or the high speed blower/vacuum outlet 40, to expose the mandrel 29 in a reverse image of the desired printed design.

The laser 34 preferably is one or a plurality of YAG infrared lasers, although ultraviolet lasers may also be used. The laser 34 may also be a continuous wave laser or a pulse laser having a power output of between 25-1200 watts. The laser 34 fires or directs a plurality of radiation pulses or a continuous wave of radiation in order to remove larger areas of the opaque mask 42 to expose the underlying mandrel 29. As discussed below, areas where the mandrel 29 is exposed are subsequently filled with metal, such as nickel, which forms the body of the printing screen and thereby prevents the flow of print paste therethrough during the printing process. By contrast, for areas where the print paste is desired to flow through the printing screen to the printing substrate, the laser 34 directs focused radiation on the mask 42 to produce a plurality of column-like structures 46 of prescribed dimensions. Specifically, the column-like structures 46 are formed by ablating or removing portions of the mask 42 to define the column-like structures from the unremoved portions of the mask. The removed portions of the mask 42 leave openings 47 surrounding the column-like structures 46. Advantageously, the structures 46 can be of any dimension and can be grouped with other structures in clusters of any size desired by ablating or removing the mask 42 to form appropriately-sized openings 47.

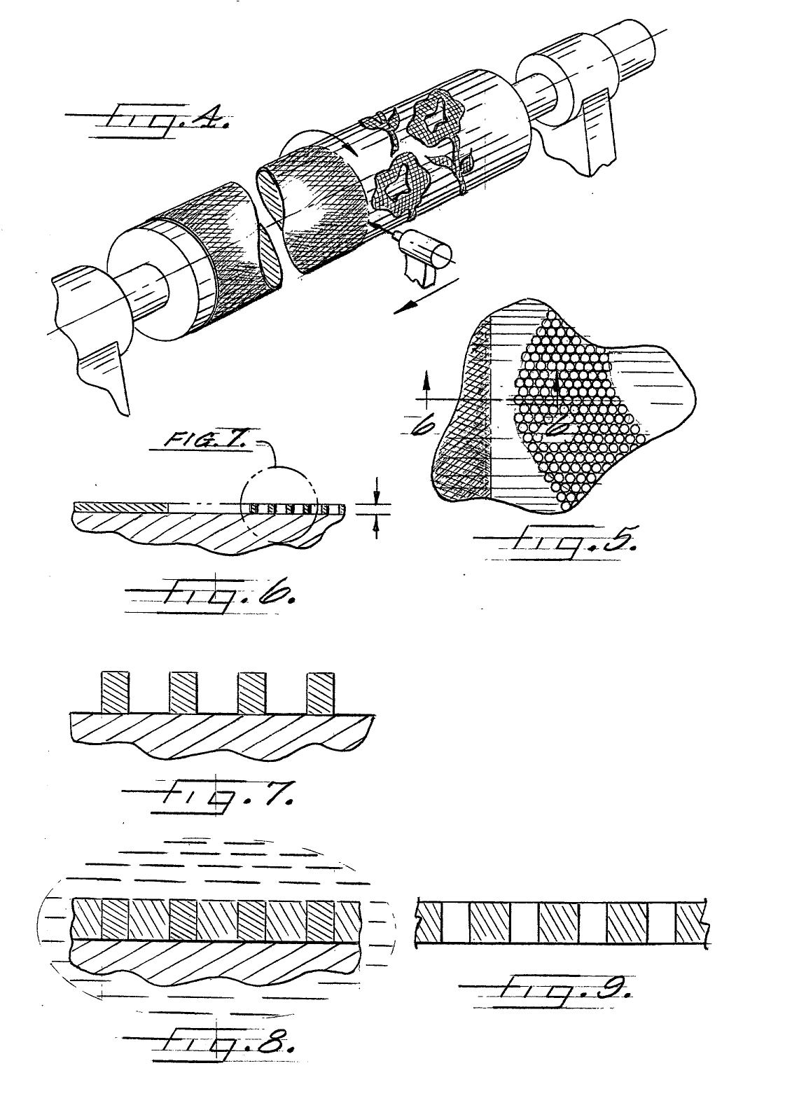

FIG. 5 shows an enlarged view from a perspective proximate the laser, and FIGS. 6-7 show greatly enlarged cross-sectional views of the mandrel 29 and mask 42 during the screen manufacturing process. As shown, a large portion of the mask 42 has been removed to define openings 47 so that the mandrel 29 is exposed. A plurality of column-like structures 46 are arranged according to the predetermined pattern 44, and a remainder of the mask 42 remains on the mandrel 29. Pursuant to the predetermined pattern 44, at least a portion of the remaining mask 42 may also be removed to complete the pattern along the length of the mandrel 29. The predetermined pattern 44 formed by the laser 34 is a negative image of an actual printed design of the printing process. Thus, the areas where the mandrel 29 is exposed become areas where print paste will not flow according to the actual printed design, while the areas where the mask 42 remains become holes 62 in the finished printing screen 64 (FIG. 9) that allow print paste to pass therethrough.

This process is repeated at designated areas on the metallic sheet so as to produce the predetermined pattern 44. In a preferred embodiment, the column-like structures 46 are formed about a particular circumferential path perpendicular to the longitudinal axis of the mandrel 29 before the engraving head 32 moves on a path parallel to the longitudinal axis of the mandrel along the track 35 to an adjacent circumferential path. In this regard, the predetermined pattern 44 is formed “one line at a time” as the engraving head 32 moves along the length of the mandrel 29 firing the laser 34. This is shown in FIGS. 4 and 5, which show a section of the mandrel 29 and mask 42 wherein the predetermined pattern 44 has been formed by the laser 34, while a remaining section has yet to have the pattern formed.

Moreover, the predetermined pattern 44 can be of any design that is amenable to the screen printing process. In this regard, the column-like structures 46 (formed by removing at least a portion of the mask 42 to define the openings 47) are spaced at different distances from each other as needed to produce the correct tonal qualities in the screen printing operation. In addition, the column-like structures 46 may have different diameters so that the finished screen 64 will deliver the correct quantity of print paste to the printing substrate and thus achieve the proper depth of shade on the printed substrate. The techniques of varying diameters and distances separating the column-like structures 46 to produce a desired effect are well known to those skilled in the art of screen printing.

FIG. 8 shows the next step in the screen manufacturing process, wherein nickel or other metal is deposited on the mandrel 29 so that areas where the mandrel is exposed are filled with metal. In a preferred embodiment, this is accomplished by immersing the mandrel 29 and mask 42 in a metallic material or metal-plating solution 48, such as a nickel-plating solution, and applying an electric charge or current thereto. Other metal-plating solutions may also be used, such as zinc, aluminum, chromium, cobalt, alloys thereof, and other inorganic multivalent materials. Alternatively, the mandrel 29 could be suspended over the plating solution 48 and rotated in the solution, or an electroless process could also be employed, which is known in the art. Regardless of the method used, metal 60 from the metal-plating solution is deposited in the openings 47 where the mandrel 29 is exposed adjacent the column-like structures 46 of the mask 42 according to the predetermined pattern 44. As discussed above, the mask 42 is a repellant material that serves as a barrier or resist to the deposition of metal 60 from the metal-plating solution 48. Therefore, the metal 60 deposited on the mandrel 29 forms a metal printing screen 64 according to the predetermined pattern 44. The printing screen 64 is then removed from the mandrel 29 according to known processes and is ready for screen printing operations.

FIG. 9 shows a greatly enlarged cross-sectional view of a metal printing screen 64 according to one embodiment that is formed of metal 60 from the metal-plating solution 48. As described above, the printing screen 64 defines a plurality of holes 62 that are formed from portions of the mask 42 that are not removed by the laser 34, wherein the laser removes portions of the mask to form a plurality of column-like structures that resist the deposition of metal and thus define the holes 62 when the printing screen 64 is removed from the mandrel 29.

As described herein, the process of manufacturing a rotary printing screen according to the present invention offers several advancements in the art. In particular, the process according to the present invention completely eliminates the need for a photographic film having a design imprinted thereon that is used to cover the mandrel for subsequent exposure to ultraviolet radiation according to photographic techniques. In addition, the mask 42 of the present invention is preferably an economical polymer-based material, rather than an expensive photosensitive coating used in conventional processes. Further, the present invention eliminates the use of electromagnetic radiation to harden photosensitive emulsions of conventional techniques. Further, the present invention eliminates the need to wash or rinse off and dispose of unexposed photosensitive emulsion effluent, which presents environmental concerns and thereby costs more in terms of disposal. As a result, the process according to the present invention is faster, more environmentally-friendly, and more economical than conventional Galvano screen manufacturing techniques and processes.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of manufacturing a printing screen that is operable for use in a rotary screen printing process, the method comprising:
applying a non-photosensitive mask to a generally cylindrical mandrel;
providing a laser operable to emit focused radiation;
removing at least a portion of the mask from the mandrel using the laser such that the mandrel is exposed where the mask is removed;
depositing a metallic material on the mandrel so that areas where the mandrel is exposed are filled with metallic material to form the printing screen; and
removing the printing screen from the mandrel.

2. A method according to claim 1, wherein the applying step includes applying a polymeric electrochemical resist mask to the mandrel.

3. A method according to claim 1, wherein the applying step includes applying an opaque polymeric electrochemical resist mask to the mandrel.

4. A method according to claim 1, wherein the mask removing step includes directly removing at least a portion of the mask by directly impinging radiation from the laser against the mask.

5. A method according to claim 1, wherein the laser providing step includes providing a laser selected from the group consisting of an infrared laser and an ultraviolet laser.

6. A method according to claim 1, wherein the mask removing step includes removing the mask in a negative image of a desired design.

7. A method of manufacturing a printing screen that is operable for use in a rotary screen printing process, the method comprising:
providing a generally cylindrical mandrel;
providing a laser operable to emit focused radiation;
applying a single layer of a resist material to at least a portion of the mandrel;
removing at least a portion of the resist material from the mandrel using the laser such that the mandrel is exposed where the resist material is removed;
immersing the mandrel having the unremoved resist material in a plating solution so that areas where the mandrel is exposed are filled with the plating solution;
applying an electric charge to the plating solution so that solidified plating forms in the areas where the mandrel is exposed; and
removing the solidified plating from the mandrel.

8. A method according to claim 7, wherein the laser providing step includes providing a laser selected from the group consisting of an infrared laser and an ultraviolet laser.

9. A method according to claim 7, wherein the resist material applying step includes applying an opaque polymeric mask to the mandrel.

10. A method according to claim 7, wherein the resist material applying step includes applying a non-photosensitive polymeric electrochemical resist mask to the mandrel.

11. A method according to claim 7, wherein the applying step includes applying a black polymeric mask to the mandrel.

12. A method according to claim 7, wherein the resist material removing step includes directly removing at least a portion of the resist material by impinging radiation from the laser against the resist material.

13. A method according to claim 7, wherein the immersing step includes immersing the mandrel in a nickel plating solution.

14. A method according to claim 7, wherein the electric current applying step includes applying an electric current so that nickel plating forms in the areas where the mandrel is exposed and substantially does not form where the mandrel is covered by the resist material.

15. A method according to claim 7, wherein the electric current applying step includes applying an electric current so that nickel plating forms in a negative image of a desired design.

16. A method of manufacturing a rotary printing screen, the method comprising:
applying a non-photosensitive mask to at least a portion of a generally cylindrical mandrel;
providing a laser operable to emit focused radiation;
removing at least a portion of the mask using a laser;
metallic plating areas where the mask is removed so that the areas are filled with a metallic material to form a metallic screen; and
removing the metallic screen from the mandrel.

17. A method according to claim 16, wherein the non-photosensitive mask applying step includes applying a polymeric electrochemical resist mask to at least a portion of the mandrel.

18. A method according to claim 16, wherein the non-photosensitive mask removing step includes directing focused radiation directly against the mask.

19. A method according to claim 16, wherein the metallic plating step includes forming a metallic screen in a negative image of a desired design.

20. A method according to claim 16, wherein the non-photosensitive mask applying step includes applying an opaque mask to at least a portion of the mandrel.

21. An apparatus for forming a printing screen that is operable for use in a rotary screen printing process, the apparatus comprising:
a generally cylindrical mandrel;
a non-photosensitive mask applied to at least a portion thereof, the mask arranged according to a predetermined pattern; and
a nickel screen removably formed on the mandrel in areas not occupied by the mask.

22. An apparatus according to claim 21, wherein the mask is an electrochemical resist mask.

23. An apparatus according to claim 21, wherein the mask is opaque.
